(19) United States
(12) Patent Application Publication
(10) Pub. No.: US 2011/0030267 A1
(43) Pub. Date: Feb. 10, 2011

(54) Biting insect trap

(76) Inventors: James A. Nolen, West Greenwich, RI (US); Robert G. Nelson, Thompson, CT (US); Daniel L. Kline, Gainesville, FL (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/660,453

(22) Filed: Feb. 26, 2010

Related U.S. Application Data
(60) Provisional application No. 61/208,817, filed on Feb. 27, 2009.

(51) Int. Cl. A01M 1/08; A01M 1/10

(52) U.S. Cl. 43/113; 43/107; 43/139

(57) ABSTRACT

The present invention is directed to a biting insect trap, comprising a base; a lower housing attached to the base and including a source of carbon dioxide disposed within the lower housing; a central housing attached to the lower housing and comprising, an induction fan, a fan discharge port, and an insect collection tray; an upper housing attached to the central housing and comprising a heating source disposed around the upper housing portion, the heating source having a heating element arranged in a pattern resembling veins and arteries; one or more insect capture ports, and an emitter disposed to emit carbon dioxide; a source of insect attractant disposed adjacent the heating element, such that the insect attractant is heated by the heating element; and a control panel comprising a controller positioned on the central housing, the controller controlling all the electronic functions of the device, as well as operation of the emitter so as to control emission of the carbon dioxide.

### CROSS-REFERENCE TO RELATED APPLICATIONS

This application claims the benefit of U.S. Provisional Application Ser. No. 61/208,817 filed Feb. 27, 2009.

### BACKGROUND OF THE INVENTION

1. Field of the Invention

The present invention relates generally to apparatuses for attracting and destroying insects, and more particularly to an apparatus having a plurality of capture ports, a heating element, a chemical attractant, and an induction fan, and a controller which work in concert to effectively capture and destroy insects.

2. Brief Description of the Related Art

Devices for attracting and destroying insects are well-known in the art. For example, U.S. Pat. No. 2,106,528 to Jones et al., U.S. Pat. No. 3,187,458 to Densmore, U.S. Pat. No. 3,835,577 to Soulos, U.S. Pat. No. 3,894,351 to Iannini, U.S. Pat. No. 4,182,069 to DeYoreo, and U.S. Pat. No. 4,387,529 to Hedstrom are representative of the available prior art devices used to attract and destroy insects. The patent to Densmore discloses a device which employs a light for attracting insects and a pesticide saturated mesh surrounding the light for killing the insects attempting to reach the light source. The remaining patents to Jones et al., Soulos, Iannini, DeYoreo and Hedstrom disclose various devices which employ an illuminating and/or odor dispensing mechanism for attracting insects, and an electrified screen grid for electrocuting insects attempting to reach the light or pheromone.

Although the electric “bug zapping” devices are popular with consumers, they have certain shortcomings. For example, the devices employing an ultraviolet light source are effective for attracting and destroying beneficial insects but are ineffective for attracting biting insects, such as mosquitoes and flies, that prey on humans and livestock. The prior art devices which utilize pheromones as the odor source to attract specific types of insects are expensive because the pheromone source is continuously active and therefore must constantly be replaced.

One solution to the foregoing problems is provided in U.S. Pat. No. 5,205,064 to Nolen, which discloses a device having a pressurized canister charged with carbon dioxide, octenol, or both, or with insect pheromones. The device further has an infrared and/or ultraviolet light source which is surrounded by an electric grid. Another solution is provided in U.S. Pat. No. 6,594,946 to Nolen et al., which discloses a mosquito and biting insect attracting and killing apparatus that includes, inter alia, a propane source which, when propane is burned, generates carbon dioxide and heat. However, the burning of propane can be dangerous in many instances, particularly in dry environments or where children are present.

What is needed in the art is an effective apparatus for attracting and eliminating flying biting insects that is safe and does not employ grids with high electric current or burning flammable materials. The present invention is believed to be an answer to that need.

### SUMMARY OF THE INVENTION

In one aspect, the present invention is directed to a biting insect trap, comprising a base; a lower housing attached to the base and including a source of carbon dioxide disposed within the lower housing; a central housing attached to the lower housing and comprising, an induction fan, a fan discharge port, and an insect collection tray; an upper housing attached to the central housing and comprising a heating source disposed around the upper housing portion, the heating source having a heating element arranged in a pattern resembling veins and arteries; one or more insect capture ports, and an emitter disposed to emit carbon dioxide; a source of insect attractant disposed adjacent the heating element, such that the insect attractant is heated by the heating element; and a control panel comprising a controller positioned on the central housing, the controller controlling operation of the emitter so as to control emission of the carbon dioxide.

This and other aspects will become apparent on reading the following description of the invention.

### BRIEF DESCRIPTION OF THE FIGURES

FIG. 1 depicts a diagram of the apparatus of the invention.

### DETAILED DESCRIPTION OF THE INVENTION

As indicated above, the present invention is a biting insect trap for attracting and eliminating flying biting insects that is safe and does not employ grids with high electric current or burning flammable materials. The present inventors have developed a trap for biting insects that includes, among other things, a source of carbon dioxide, a heating element that mimics the arteries and veins of a mammal, and one or more chemical attractants. The carbon dioxide, heating element, and chemical attractants work in concert to attract flying biting insects such as mosquitoes and other pests. Moreover, the present invention collects these flying biting insects by sucking them into a collection vessel with the aid of an induction fan. This feature offers advantages over electrified grids or the burning of propane utilized in devices in the prior art in terms of safety and economy.

Accordingly, the present invention is directed to a biting insect trap, comprising a base; a lower housing attached to the base and including a source of carbon dioxide disposed within the lower housing; a central housing attached to the lower housing and comprising, an induction fan, a fan discharge port, and an insect collection tray; an upper housing attached to the central housing and comprising a heating source disposed around the upper housing portion, the heating source having a heating element arranged in a pattern resembling veins and arteries; one or more insect capture ports, and an emitter disposed to emit carbon dioxide; a source of insect attractant disposed adjacent the heating element, such that the insect attractant is heated by the heating element; and a control panel comprising a controller positioned on the central housing, the controller controlling all the electronic functions of the device (described in detail below), as well as operation of the emitter so as to control emission of the carbon dioxide. Each of these elements are described in detail below.

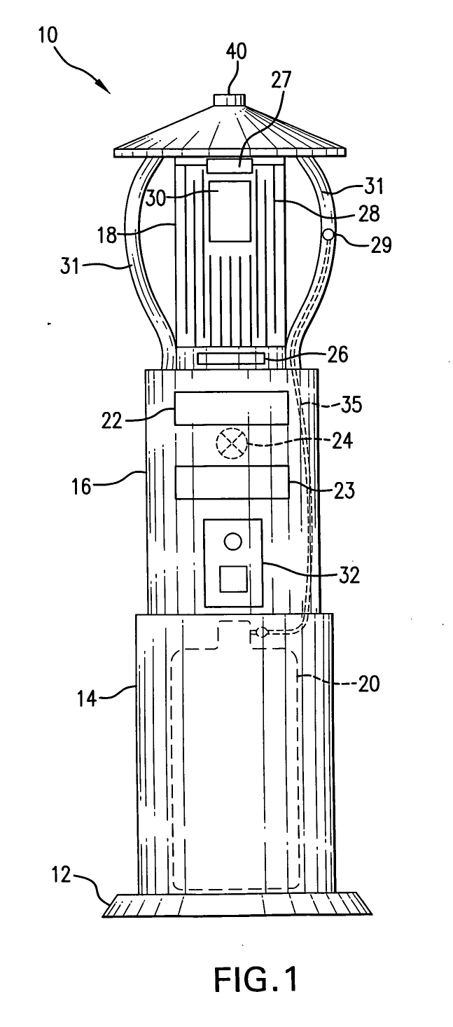

FIG. 1 shows the biting insect trap that is the subject of the invention. As shown in FIG. 1, the apparatus 10 includes a base 12, a lower housing 14, a central housing 16, and an upper housing 18. The lower housing 14 includes a carbon dioxide tank 20 (shown in phantom) as a source of carbon dioxide. The central housing 16 includes an induction fan 24 mounted inside the central housing 16 (shown in phantom), a fan discharge port 23, and an insect collection tray 22. An upper housing 18 is mounted on the lower housing 16 and includes a heating source 28. The heating source 28 includes a heating element that is arranged in a pattern that resembles veins and arteries in a mammal. A source of chemical attractant 30 is mounted on the upper housing 18 and adjacent to the heating source 28. An upper capture port 27 and a lower capture port 26 are positioned at the top and bottom of the upper housing 18 and are effective in capturing high-flying and low-flying insects, respectively. A light 40 is mounted at the top of the device. A carbon dioxide emission port 29 is positioned on at least one of the support arms 31, and is connected to the carbon dioxide tank 20 by a hose 35. The carbon dioxide emission port 29 allows the carbon dioxide from the carbon dioxide tank 20 to be emitted in a controlled fashion adjacent to the chemical attractant 30 and the heating source 28 for maximum effectiveness. The hose 35 may include a permeable portion (similar to a soaker hose) proximate to the carbon dioxide emission port in order to facilitate a gradual emission of carbon dioxide into the local environment.

A control panel 32 is mounted on the central housing 16 to control the device and particularly the emission of carbon dioxide. In one embodiment, the control panel 32 of the apparatus 10 includes a photocell sensor, a status light emitting diode (LED), and a mode switch. The photocell sensor is responsive to ambient light and can track sunrise and sunset over the summer. The status LED displays operating modes and warning indications to the user, such as when to replace the chemical attractant or that the carbon dioxide tank is low. The mode switch comprises a one-button switch that toggles the device through various operating modes (described below) or to the off position.

The apparatus operates as follows. Carbon dioxide is released from the carbon dioxide emission port 29 about every 5 seconds. A carbon dioxide emission rate of about every 5 seconds is preferable because it simulates the exhaled breath of a small animal. In one embodiment, the device is capable of monitoring the amount of carbon dioxide remaining in the carbon dioxide tank 20 and lets the user know when the bottle depleted by a flashing light. In addition, as the heating source 28 is warmed, the heating element produces an infrared image of arteries and veins near the surface of the skin and the body temperature of a small animal. Preferably, the temperature of the heating element is maintained at a temperature of from 85 to 115 degrees Fahrenheit. As the heating element is heated, insect attractants contained within a source 30 are also warmed and activated. These chemical attractants then evaporate into the carbon dioxide plume that is emitted from the emitter 26. Any chemical attractant may be used with the present invention. Examples of chemical attracts include kairomones such as alkenols (e.g., octenol), alkynols (octynol), gases such as carbon dioxide, nitrogen dioxide, as well as substances such as carboxylic acids, butyric acids, caproic acids, propionic acids, valeric acids, ammonia, and acetone. (See U.S. Pat. Nos. 6,866,858; 5,799,436; 6,660,775, all of which are herein incorporated by reference in their entireties). Examples of pheromones that could be useful in the invention include species-specific mating pheromones, such as those for Japanese beetle, potato beetle, coddling moth, boweivel, corn borer, etc., as well as pheromone inhibitors useful, for example, for mating disruption. One of skill in the art will further appreciate that any combinations of the above-mentioned chemicals may also be implemented in the apparatus of the invention.

The attractant may be used alone, or may be used with a carrier. The carrier may function to control the release of the attractant so that an optimum amount of attractant is released. For example, the attractant compound can be formulated in a specially formulated waxy medium or vehicle engineered to release desired amounts of vaporous attractant compound at ambient temperatures, such as those waxy mediums or vehicles available from Koster Keunen of Watertown, Conn. An example of such a waxy medium available from Koster Keunen is known as Insect Repellent Wax Bar No. 9, which is a blend of fatty, paraffinic, and branched chain hydrocarbons, as well as beeswax and other natural waxes. Alternatively, the attractant can be formulated in a porous medium or vehicle suitable for releasing effective amounts of the attractant compound. As an example of such porous medium or vehicle is a polyester membrane material having micropores encasing a block of inhibiting compound saturated fibers that gradually releases the inhibiting compound so that it permeates the microporous membrane and is released to the environment. Such porous membrane known as World of Fragrance cups is available from Waterbury Companies, Inc. of Waterbury, Conn.

In operation, biting flying insects such as mosquitoes follow the carbon dioxide and chemical plume until they detect the heat from the heating source. Mosquitoes have body heat sensors on the tip of their antennae that can detect a human from 10 feet (3 m) away, and on humid nights they can detect a human from as much as 30 feet (10 m) away. Because their mouthparts cannot reach the blood supply except where it is close to the skin, and because these areas of the body are slightly warmer than other areas, insects use heat sensors to choose the best place to land and bite. In addition, since it is known that mosquitoes typically circle their prey before landing, it has been observed that they approach the apparatus of the invention and fly around it. When mosquitoes fly too close or attempt to land on the heating source, their path is intercepted by one of the capture ports in the upper housing housing. Suction from the induction fan mounted inside the central housing results in the mosquitoes being sucked through the capture ports 26, 27 and into a collection tray 22 inside the central housing where they cannot escape. Within several hours the captured mosquitoes die of dehydration from the air passing over them.

Unlike propane traps of the prior art, the apparatus of the present invention is effective to capture all four major groups of mosquitoes in North America and around the world, including mosquitoes found near salt water (e.g., ocean, bays, estuaries), mosquitoes found near fresh water (e.g., lakes, ponds, swamps), mosquitoes found near snow-melt (e.g., rivers, streams), and mosquitoes that breed in containers (e.g., tree-hole, automobile tires). The apparatus of the invention is useful for attracting and trapping flying, biting insects such as biting midges and biting mosquitoes of various species including Aedes taeniorhyncus (Black Salt Marsh mosquito), Culex nigripalpus, Aedes aegypti, Aedes albopictus (Asian Tiger mosquito), Culex pipiens (common house mosquito), Culex quinquefasciatus, Anopheles gambiae, disease vectors such as Aedes japonicus, and the like. In tests against the leading propane mosquito traps, the apparatus of the present invention proved consistently superior, even though it uses less carbon dioxide was used than propane traps.

While the preferred mode of operation of the apparatus of the invention is with carbon dioxide as an attractant, in an alternative embodiment, the apparatus of the invention may be used without the carbon dioxide attractant. Nevertheless, operating costs are minimized by prudent use of carbon dioxide, which is less expensive than propane, and 30-day kairomone lures. In addition, selectable, preprogrammed cycles deliver convenient, season-long set-and forget operation, minimizing maintenance (described in more detail below). Moreover, the apparatus of the invention is carbon neutral. The carbon dioxide used is recycled from the atmosphere. Unlike propane mosquito traps, it does not add to greenhouse gases in the atmosphere.

The apparatus of the invention is preferably placed between the area to be protected and the places mosquitoes live (forest, meadow, water, etc.), and about 30 feet (10 meters) from the areas that are to be protected. This placement is preferred in order to avoid the insects being attracted to the motion of people or animals.

As indicated above, the apparatus of the invention can be controlled through the control panel 32. Proper control of the apparatus of the invention results in the device being highly effective in controlling flying biting insect pests in the desired areas. In one aspect, control of the device through the control panel 32 and related elements allows the device to operate at maximum efficiency, use the least amount of consumable items such as carbon dioxide, and provide the most enhanced biting insect attraction. In one embodiment, the apparatus of the invention includes photocell that senses sunrise and sunset, and signals the microprocessor as the days grow longer or shorter over the summer. Thus the device has the ability to track sunrise and sunset throughout the summer, and activate at the proper times to establish and maintain mosquito control. Relatedly, it is preferable to place the apparatus away from outdoor light sources so that they do not interfere with this level of control.

The control panel 32 and related elements offer additional levels of control (operating modes) to make the apparatus of the invention effective, convenient to use, and economical. In one embodiment, the apparatus of the invention includes user-programmable modes that allow the user to match the operation of the device with the user's outdoor activities so that the device is active to capture and destroy flying biting insects during those outdoor activities. In addition, pre-programmed automatic modes are also included in the control elements so that the apparatus will be operative at dawn and dusk, times which are known to have high levels of mosquito activity. Table 1 below summarizes one set of operating modes of the apparatus of the invention. The user selectable modes correspond to the times people enjoy the outdoors (afternoon, evening and night).

TABLE 1

| Mode | | On | Off |
|---|---|---|---|
| User | Afternoon | 5 Hours before Sunset | 1 Hour before Sunset |
| Selected | Evening | 1 Hour before Sunset | 2 Hours after Sunset |
| | Night | 1 Hour before Sunset | 4 Hours after Sunset |
| Automatic | Dawn | 1 Hour before Sunrise | 1 Hour after Sunrise |
| | Dusk | 1 Hour before Sunset | 4 Hours after Sunset |

Table 2 shows combinations of attractants that are controlled by the apparatus of the invention and how they are emitted at certain times of the day and under selected programming modes.

TABLE 2

| Mode | | CO₂ | Attractant | Heat | Light* |
|---|---|---|---|---|---|
| User Selected | Afternoon | ✓ | ✓ | ✓ | |
| | Evening | ✓ | ✓ | ✓ | ✓ |
| | Night | ✓ | ✓ | ✓ | ✓ |
| Automatic | Dawn | | ✓ | ✓ | ✓ |
| | Dusk | | ✓ | ✓ | ✓ |

*Light is on only in darkness between sunset and sunrise

As shown in Table 2, the apparatus of the invention combinations of four powerful attractants: carbon dioxide, chemical attractants (host odors such as breath and skin emanations that attract mosquitoes), heat (the thermal image of blood near the surface of the skin), and light. Carbon dioxide is used only in the afternoon, evening or night modes. Heat, attractants, and light are used without carbon dioxide in automatic mode at Dawn and Dusk.

In another embodiment, two levels of carbon dioxide release are available through the control panel. For most areas the light to moderate release mode is adequate and uses less carbon dioxide, thus extending the time between carbon dioxide bottle replacement. For periods of heavy mosquito activity, it may be necessary to use the moderate to heavy mode. Using the light to moderate setting, approximately 16 ounces of liquid carbon dioxide will last about 27 hours, while the same amount at the moderate to heavy setting will last about 40 hours. Using larger carbon dioxide bottles, which are also available in 20 and 24 ounce size, extends the time between carbon dioxide bottle replacement. Table 3 shows approximate lengths of time a carbon dioxide bottle will last under various of the operational modes.

TABLE 3

| | Liquid Carbon Dioxide (ounces) | | | |
|---|---|---|---|---|
| Operating Mode | 32 | 16 | 20 | 24 |
| Evening, light activity | 26 days | 13 days | 16 days | 19 days |
| Night, light activity | 16 days | 8 days | 10 days | 12 days |
| Afternoon, light activity | 20 days | 10 days | 12 days | 15 days |
| Evening, heavy activity | 18 days | 9 days | 11 days | 13 days |
| Night, heavy activity | 10 days | 5 days | 6 days | 7 days |
| Afternoon, heavy activity | 14 days | 7 days | 9 days | 10 days |
| Manual | 54 hours | 27 hours | 34 hours | 40 hours |

In addition, manual mode provides mosquito protection on demand any time of day or night. In manual mode, the apparatus of the invention is activated for about 4 hours, and then returns to its previous Mode setting. Manual Mode is ideal for unexpected guests, or an irregular schedule of outdoor activities.

The invention may also optionally contain communications systems and software permit the device to communicate with others of this same device, or other devices, in order to optimize effectiveness of the devices in large areas. In both embodiments, the disclosed optional systems could independently control emission of carbon dioxide, induction fan speed, and the heating source across each device and in real time so that operational effectiveness is maximized and operational costs and consumption rate of supplies (e.g., carbon dioxide and chemical attractant) is minimized. In particular, the invention may also include wireless controller functions and information processing and storage circuitry that permits the apparatus of the invention to collect data and communicate with the user wirelessly at a remote location.

In one embodiment, the apparatus of the invention includes electronic systems and software that analyze the number of insects collected within a selected time period. This particular information is useful and can enhance the effectiveness of the apparatus in at least three areas. First, these systems can recognize patterns of insect activity at certain times of the day. This pattern recognition allows the apparatus to adjust its parameters proactively at certain times of the day that are known to correspond to increased or decreased activity of insects, for example. Second, these systems can implement adaptive control so that the apparatus can adjust its parameters to meet increased or decreased activity of insects, independent of the time of day. Third, these systems provide for enhanced insect monitoring functionality. Coupled with wireless connectivity, the user can monitor the performance of the device and its effectiveness from a remote location.

Although the invention has been shown and described with respect to illustrative embodiments thereof, it should be appreciated that the foregoing and various other changes, omissions and additions in the form and detail thereof may be made without departing from the spirit and scope of the invention as delineated in the claims. All patents, patent applications, and literature publications mentioned are herein incorporated by reference in their entireties.

What is claimed is:

1. A biting insect trap, comprising:
a base;
a lower housing attached to said base and including a source of carbon dioxide disposed within said lower housing;
a central housing attached to said lower housing and comprising, an induction fan, a fan discharge port, and an insect collection tray;
an upper housing attached to said central housing and comprising a heating source disposed around said upper housing portion, said heating source having a heating element arranged in a pattern resembling veins and arteries; one or more insect capture ports, and an emitter disposed to emit carbon dioxide;
a source of insect attractant disposed adjacent said heating element, such that said insect attractant is heated by said heating element; and
a control panel comprising a controller positioned on said central housing, said controller controlling operation of said emitter so as to control emission of said carbon dioxide.

2. The biting insect trap of claim 1, wherein said one or more insect capture ports comprise an upper capture port and a lower capture port.

3. The biting insect trap of claim 1, wherein said emitter comprises a valve operatively coupled to a nozzle of a canister of pressurized carbon dioxide.

4. The biting insect trap of claim 1, wherein said heating element is maintained at a temperature of from 85 to 115 degrees Fahrenheit.

5. The biting insect trap of claim 1, wherein said emitter emits carbon dioxide gas at approximately 5 second intervals.

6. The biting insect trap of claim 1, wherein said insect attractant is selected from the group consisting of octenol, R-octenol, carboxylic acids, butyric acids, caproic acids, propionic acids, valeric acids, ammonia, acetone, and combinations thereof.

7. The biting insect trap of claim 1, wherein said insect attractant further comprises a carrier.

8. The biting insect trap of claim 1, wherein said control panel further comprises an ambient light sensor.

9. The biting insect trap of claim 1, wherein said control panel further comprises electronic systems that monitor the time of day and capture rate.

10. The biting insect trap of claim 1, wherein said upper housing further comprises one or more support arms, and wherein said emitter is disposed on said support arms.
